(19) United States
(12) Patent Application Publication
(10) Pub. No.: US 2018/0109317 A1
(43) Pub. Date: Apr. 19, 2018

(54) BI-DIRECTIONAL PROPAGATION IN OPTICAL COMMUNICATION

(71) Applicant: Finisar Corporation, Sunnyvale, CA (US)

(72) Inventors: Jonathan Paul King, San Francisco, CA (US); Christopher R. Cole, Redwood City, CA (US)

(21) Appl. No.: 15/720,010

(22) Filed: Sep. 29, 2017

Related U.S. Application Data
(60) Provisional application No. 62/407,926, filed on Oct. 13, 2016.
(60) Provisional application No. 62/418,604, filed on Nov. 7, 2016.

(51) Int. Cl. H04B 10/25; H04B 10/40; H04J 14/02

(52) U.S. Cl. CPC H04B 10/2503; H04J 14/02; H04B 10/40

(57) ABSTRACT

Various embodiments relate to bi-directional optical communication. An optical system may include a first transceiver module including at least one transmitter and at least one receiver, wherein each transmitter of the at least one transmitter is configured to transmit a first signal via an optical fiber and at a wavelength. The optical system may further include a second transceiver module configured to communicate with the first transceiver module via the optical fiber and including at least one transmitter and at least one receiver, wherein each transmitter of the at least one transmitter of the second transceiver module is configured to transmit a second signal via the optical fiber and at another, different wavelength.

### CROSS-REFERENCE TO RELATED APPLICATIONS

A claim for benefit of priority to the Oct. 13, 2016 filing date of the U.S. Patent Provisional Application No. 62/407,926, titled “BI-DIRECTIONAL PROPAGATION IN OPTICAL COMMUNICATION” (the '926 Provisional Application), and the Nov. 7, 2016 filing date of the U.S. Patent Provisional Application No. 62/418,604, titled “BI-DIRECTIONAL PROPAGATION IN OPTICAL COMMUNICATION” (the '604 Provisional Application), is hereby made pursuant to 35 U.S.C. § 119(e). The entire disclosures of the '926 Provisional Application and the '604 Provisional Application are hereby incorporated herein.

### FIELD

The embodiments discussed herein relate to optical communication. In particular, some embodiments relate to bi-directional propagation in optical communication systems.

### BACKGROUND

Some optical transceivers receive data (e.g., from an optical transceiver) via an optical fiber and transmit data (e.g., to the optical transceiver) via another, different optical fiber. Bi-directional (BiDi) optical transceivers are configured to transmit and receive data via a single optical fiber.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example embodiment includes an optical system. The optical system may include a first transceiver module including at least one transmitter and at least one receiver. Each transmitter of the at least one transmitter may be configured to transmit a first signal via an optical fiber and at a wavelength. The optical system may also include a second transceiver module configured to communicate with the first transceiver module via the optical fiber. The second transceiver module may include at least one transmitter and at least one receiver. Each transmitter of the at least one transmitter of the second transceiver module may be configured to transmit a second signal via the optical fiber and at another, different wavelength.

According to another embodiment, an optical system may include a first transceiver layer including at least one optical transceiver configured to transmit a first optical signal via an optical fiber and at a first wavelength. The optical system may further include a second transceiver layer including at least one optical transceiver configured to receive the first optical signal via the optical fiber and transmit a second optical signal via the optical fiber and at a second, different wavelength.

According to another embodiment, the present disclosure includes methods for operating an optical communication system. Various embodiments of such a method may include transmitting a first optical signal at a first wavelength from a first optical transceiver to a second optical transceiver via an optical fiber. The method may also include transmitting a second optical signal at a second, different wavelength from the second optical transceiver to the first optical transceiver via the optical fiber.

The object and advantages of the embodiments will be realized and achieved at least by the elements, features, and combinations particularly pointed out in the claims. Both the foregoing general description and the following detailed description are exemplary and explanatory and are not restrictive.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts an example optical system;

FIG. 2 is a plot depicting an example coarse wavelength division multiplexing (CWDM) receiver demultiplexer response;

FIG. 3 is a plot depicting another example CWDM receiver demultiplexer response, wherein CWDM channels are divided into two transmit bands;

FIG. 4 illustrates an example optical system;

FIG. 5 illustrates an example optical system including a plurality of transceiver layers and a plurality of switch layers;

FIG. 6 is a flowchart of an example method for operating an optical communication system;

FIG. 7 illustrates an example optical communication system;

FIG. 8 depicts an example transceiver positioned proximate a heating and cooling device;

FIG. 9 illustrates an example optical system including heating and cooling devices; and

FIG. 10 is a plot depicting a plurality of signals at different wavelengths.

### DESCRIPTION OF SOME EXAMPLE EMBODIMENTS

Optical bi-directional products (e.g., 100G-CWDM LR4 transceivers) are configured to counter propagate on a single optical fiber. Counter propagating signals may have identical wavelengths, and, thus undesirable reflections (e.g., at connectors and transceiver interfaces (e.g., internal and/or external to a transceiver)) may exist.

Various embodiments of the present disclosure relate to bi-directional propagation in optical communication. More specifically, various embodiments relate to subdividing optical channels into a plurality of bands (e.g., two bands) and, thus, during operation, an optical spectrum propagated in one direction may be incoherent with an optical spectrum propagated in an opposite direction.

In at least one embodiment, an optical system may include a first transceiver module including at least one transmitter and at least one receiver. In some embodiments, the first transceiver module may be part of a transceiver layer (e.g., a first transceiver layer). Each transmitter of the at least one transmitter may be configured to transmit a first signal via an optical fiber and at a wavelength. The optical system may also include a second transceiver module configured to communicate with the first transceiver module via the optical fiber. The second transceiver module may include at least one transmitter and at least one receiver. In some embodiments, the second transceiver module may be part of a transceiver layer (e.g., second transceiver layer). Each transmitter of the at least one transmitter of the second transceiver module may be configured to transmit a second signal via the optical fiber and at another, different wavelength. In these and other embodiments, the first signal and the second signal may be configured to counter propagate via the optical fiber.

Further, in some embodiments, the optical system may include an additional transceiver layer (e.g., a third transceiver layer) including a third transceiver module configured to communicate with the second transceiver module via a second, different optical fiber. The third transceiver module may include at least one transmitter and at least one receiver, wherein each transmitter of the at least one transmitter of the third transceiver module may be configured to transmit a third signal via the second optical fiber and at the wavelength.

According to some embodiments, the first transceiver module may be configured to transmit the first signal in a first portion of each wavelength-division multiplexing (WDM) channel of a plurality of WDM channels and the second transceiver module may be configured to transmit the second signal in a second, different portion of each WDM channel of the plurality of WDM channels. More specifically, for example, in some embodiments, the first transceiver module may configured to transmit the first signal in a first band of a WDM channel and the second transceiver module may be configured to transmit the second signal in a second, different band of the WDM channel.

Moreover, according to some embodiments, the optical system may include a switch layer coupled between the first transceiver layer and the second transceiver layer. The switch layer may include, for example, one or more optical switches.

Some additional details of these and other embodiments are described with reference to the appended figures. In the appended figures, structures and features with the same item numbers are substantially the same unless indicated otherwise.

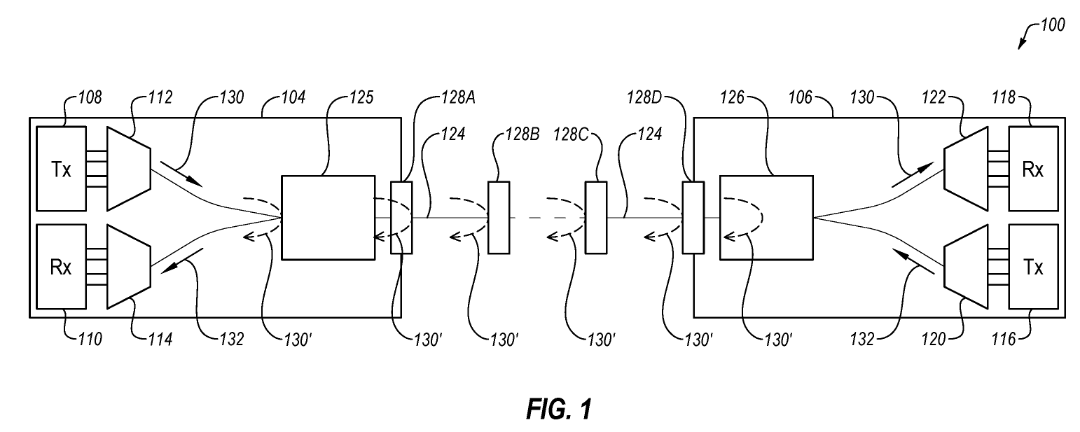

FIG. 1 depicts an optical system 100 including a transceiver module 104 and a transceiver module 106. Transceiver module 104 includes a transmitter 108, a receiver 110, a multiplexer 112, and a demultiplexer 114. Transceiver module 106 includes a transmitter 116, a receiver 118, a multiplexer 120, and a demultiplexer 122. According to some embodiments, each of transmitter 108 and transmitter 116 may include a single transmitter or a wavelength division multiplexed (WDM) transmitter. Optical system 100 further includes an optical fiber 124, circulators 125 and 126, and fiber connectors 128A-128D.

In one contemplated operation, transmitter 108 and transmitter 116 may share a single optical fiber (i.e., optical fiber 124), wherein a signal transmitted from transmitter 108 to receiver 118 may propagate in an opposite direction of a signal transmitted from transmitter 116 to receiver 110. Stated another way, signals transmitted by transmitter 108 and transmitter 116 may counter propagate with essentially the same set of nominal center wavelengths.

For example, if transmitter 108 and transmitter 116 utilize the same wavelength (e.g., to within a fraction of 1 nm), coherent crosstalk between, for example, reflected portions 130′ of a signal 130 conveyed by transmitter 108 and a signal 132 conveyed from transmitter 116 may result in significant system penalties. Reflected portions 130′ of signal 130 may be due to, for example, connector interfaces along the fiber link (i.e., including optical fiber 124) and/or or reflections within a transceiver (e.g., transceiver module 104 and/or transceiver module 106).

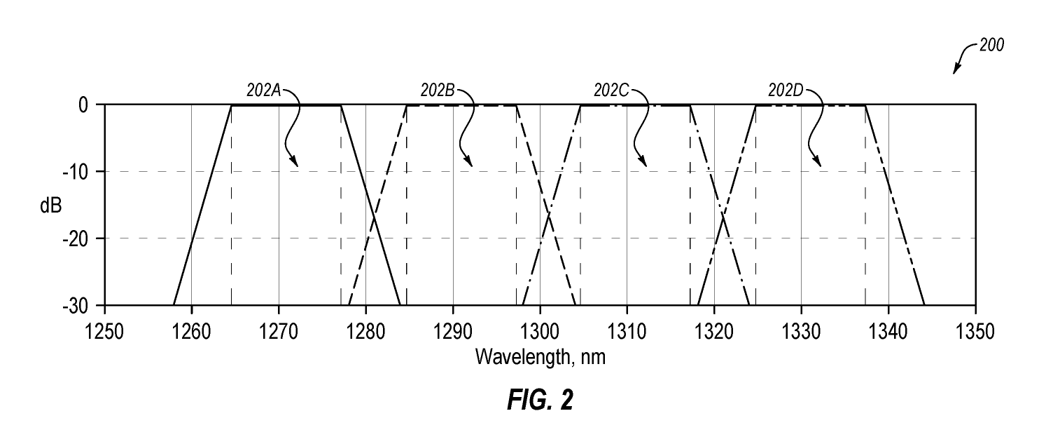

FIG. 2 is a plot 200 depicting an example coarse wavelength division multiplexing (CWDM) receiver demultiplexer response. In conventional systems, a transmitter may transmit a signal at a wavelength that spans an entire width of a CWDM channel. More specifically, with reference to plot 200, which depicts CWDM channels 202A-202D, a transmitter may transmit a signal at a wavelength that spans an entire width of each CWDM channel 202A-202D.

According to various embodiments of the present disclosure, to limit, and possibly prevent, coherent crosstalk between transceivers utilizing a bidirectional fiber link, each transmitter may transmit at different wavelengths. More specifically, for example, each transmitter of an optical communication system may be allocated a portion (e.g., a band) within each optical channel. As a more specific example, according to some embodiments, one transmitter (e.g., transmitter 108) may be configured to utilize a “left” or “lower” band of each channel and another transmitter (e.g., transmitter 116) may be configured to utilize a “right” or “upper” band of each channel.

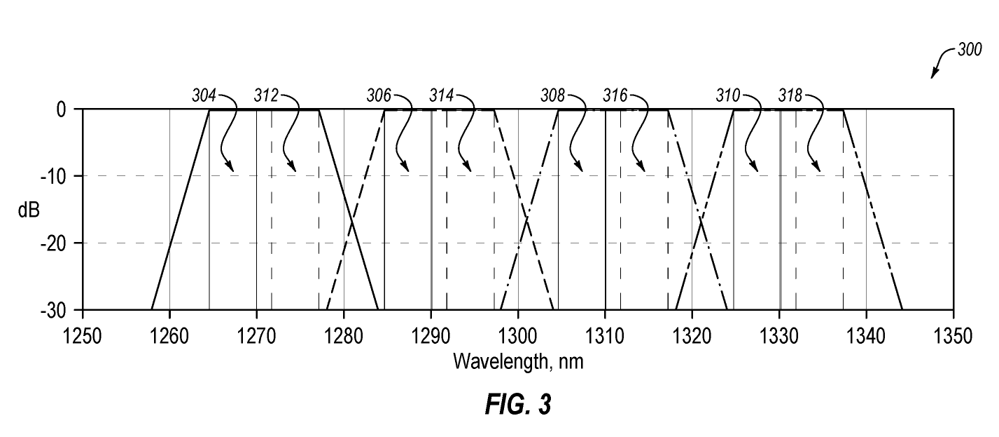

FIG. 3 is a plot 300 depicting another example CWDM receiver demultiplexer response, wherein CWDM channels are divided into two transmit bands. With reference to plot 300, each CWDM channel includes two portions (e.g., two transmit bands). In one example, wherein two transmitters are utilizing a bidirectional fiber link, a first transmitter may utilize a portion 304 of CWDM channel 202A (see FIG. 2), a portion 306 of CWDM channel 202B (see FIG. 2), a portion 308 of CWDM channel 202C (see FIG. 2), and a portion 310 of CWDM channel 202D (see FIG. 2). Further, in this example, a second transmitter may utilize a portion 312 of CWDM channel 202A, a portion 314 of CWDM channel 202B, a portion 316 of CWDM channel 202C, and a portion 318 of CWDM channel 202D.

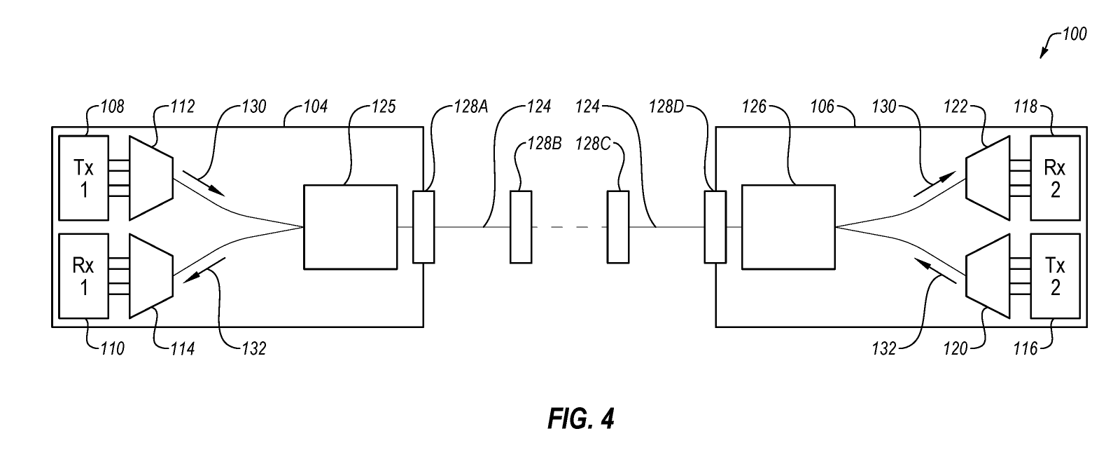

FIG. 4 is another illustration of optical system 100. However, in contrast to FIG. 1, in this scenario, transmitter 108 and transmitter 116 are configured to transmit at different wavelengths and, therefore, coherent crosstalk between transceiver modules 104 and 106 may be limited, and possibly avoided. It is noted that receiver characteristics may be unchanged, thus, each transceiver (e.g., transceiver 104 and/or transceiver 106) may still interoperate with each other and with conventional CDWM transceivers in unidirectional links (e.g., where transmit and receive have different fibers).

According to some embodiments, each of transmitter 108 and transmitter 116 may include at least one laser for transmitting an optical signal. Further, according to various embodiments, lasers for optical system 100 may be selected to transmit optical signals at desired wavelengths. For example, a laser may be tested (e.g., within a temperature range) to determine a center wavelength of the laser. Further, based on test results, the laser may be selected for a specific transceiver. More specifically, for example, based on a measured center wavelength of the laser, the laser may be selected for use within either transceiver module 104 or transceiver module 106. Further, in some embodiments, one or more transmitter optical subassembly (TOSA) heaters may be used to limit a wavelength range of one or more lasers and/or a transceiver temperature range may be used to limit a wavelength range of the one or more lasers.

Further, in one or more embodiments, one or more coolers (e.g., thermoelectric coolers (TEC)) may be used to reduce a temperature range proximate one or more lasers of a transceiver. For example, if two lasers (e.g., a “left laser” and a “right laser”) of a transceiver are positioned proximate (e.g., positioned on) a cooler (e.g., a TEC), the “left” wavelengths may be skewed shorter (e.g., by ½ nm by operating 5 degrees cooler than nominal (e.g., 45 degrees C.)), and the “right” wavelengths may be skewed longer (e.g., by ½ nm by operating 5 degrees warmer than nominal (e.g., 55 degrees C.). This may result in “left” and “right” separation (e.g. 1 nm separation). In addition, grouping the lasers into wavelengths shorter than at nominal temperature and wavelengths longer than at nominal temperature may provide for increased separation (e.g., 2 nm separation, 3 nm separation, 4 nm separation, etc.). In at least one embodiment, a TEC may hold the wavelengths nearly constant as the environmental temperature changes.

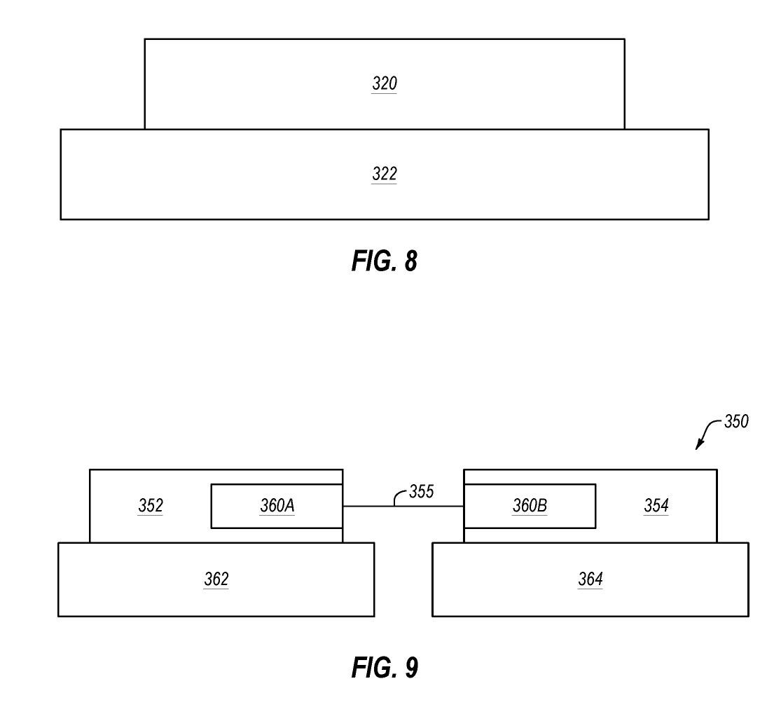

As an example, FIG. 8 depicts an example transceiver 320 positioned proximate an example heating and cooling device 322, which may be configured for heating and/or cooling. In one example, heating and cooling device 322 may comprise a TOSA heater, a thermoelectric cooler, or both.

Further, FIG. 9 depicts an example optical system 350 including a plurality of transceivers 352 and 354, wherein each transceiver 352 and 354 includes at least one laser 360. Optical system 350 further includes an optical fiber 355. Optical system 350 includes a heating and cooling device 362 positioned proximate transceiver 352 and a heating and cooling device 364 positioned proximate transceiver 354. By way of example, each of heating and cooling device 362 and heating and cooling device 364 may include a thermoelectric cooler. In at least one embodiment, heating and cooling device 362 may be configured to cool laser 360A, for example, five degrees cooler than normal (e.g., 45 degrees C.), and heating and cooling device 364 may be configured to heat laser 360B, for example, five degrees warmer than normal (e.g., 55 degrees C.). In these and other embodiments, wavelengths of lasers 360 may be skewed (e.g., by ½ nm, 1 nm, 2 nm, etc.) in opposite directions, and thus, resulting in a wavelength separation (e.g., 1 nm separation, 2 nm separation, 3 nm separation, etc.) between lasers 360. Accordingly, in some embodiments, transceiver 352 may be configured to transmit utilizing a “left” band of each channel and transceiver 354 may be configured to transmit utilizing a “right” band of each channel, or vice versa.

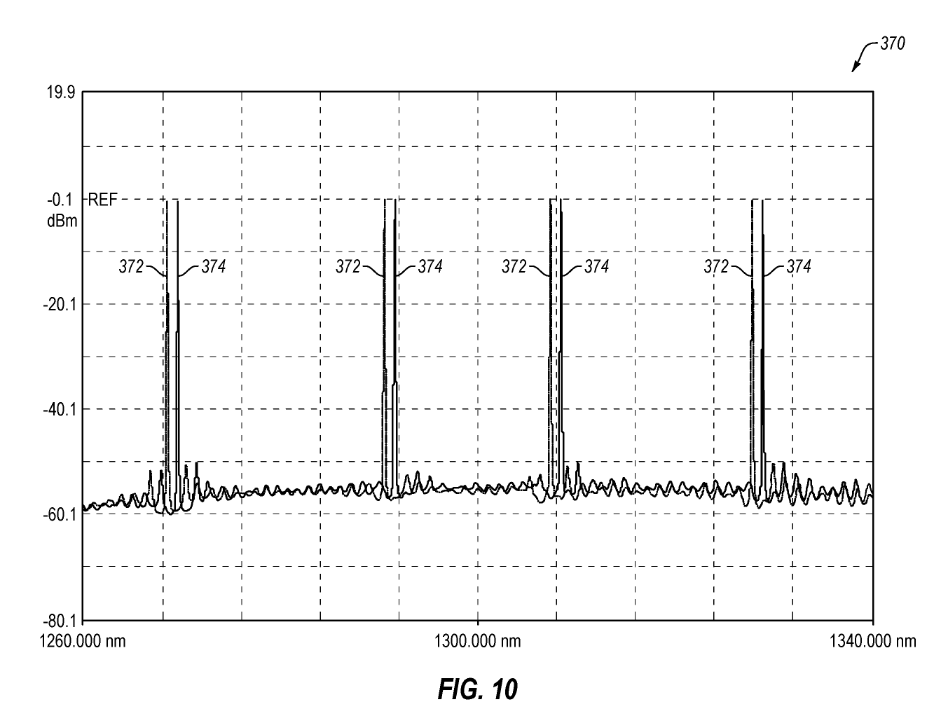

FIG. 10 is a plot 370 illustrating two signals 372 and 374, wherein one signal is transmitted via a laser that is cooled (e.g., at 45 degrees C.) and the other signal is transmitted via a laser that is heated (e.g., at 55 degrees C.). More specifically, for example, signal 372 may be transmitted via a laser that is cooled (e.g., at 45 degrees C.) and signal 374 may be transmitted via a laser that is heated (e.g., at 55 degrees C.). According to some embodiments, the wavelengths of signals 372 and 374 may be separated by approximately 1 nm.

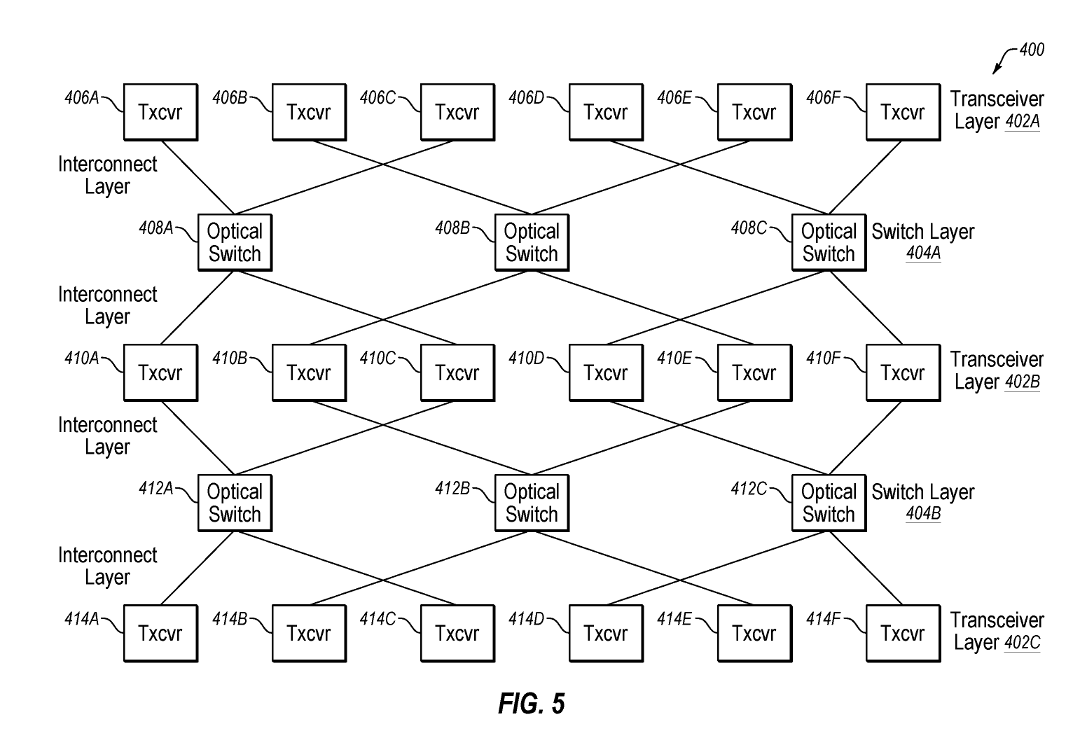

FIG. 5 illustrates an example optical system 400 including a plurality of transceiver layers 402A-402C and a plurality of switch layers 404A and 404B. Transceiver layer 402A includes a plurality of transceivers 406A-406F, transceiver layer 402B includes a plurality of transceivers 410A-410F, and transceiver layer 402C includes a plurality of transceivers 414A-414F. Moreover, switch layer 404A includes a plurality of optical switches 408A-408C, and switch layer 404B includes a plurality of optical switches 412A-412C.

According to various embodiments, each transceiver in a transceiver layer may communicate with one or more transceivers in an adjacent transceiver layer. More specifically, for example, each transceiver in transceiver layer 402A may communicate with one or more transceivers in transceiver layer 402B. Furthermore, each transceiver in transceiver layer 402B may communicate with one or more transceivers in transceiver layer 402C.

With continued reference to system 400, in at least one embodiment, transceivers in adjacent transceiver layers may transmit signals at different wavelengths. More specifically, for example, each transceiver in transceiver layer 402A may transmit signals at a first wavelength and each transceiver in transceiver layer 402B may transmit signals at a second, different wavelength. Further, for example, each transceiver in transceiver layer 402C may transmit signals at the first wavelength. Stated another way, each transceiver 406 in transceiver layer 402A and each transceiver 414 in transceiver layer 402C may be configured to transmit in a first band of a channel, and each transceiver 410 in transceiver layer 402B may be configured to transmit in a second band of a channel. Therefore, coherent crosstalk between transceivers in transceiver layer 402A and transceivers in transceiver layer 402B may be limited, and possibly avoided. Similarly, coherent crosstalk between transceivers in transceiver layer 402B and transceivers in transceiver layer 402C may be limited, and possibly avoided.

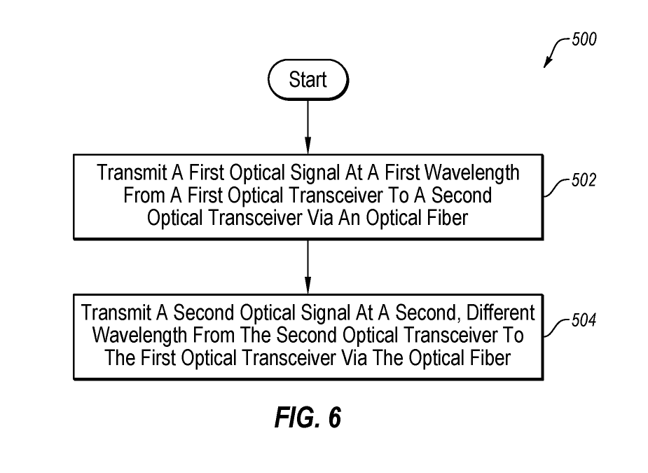

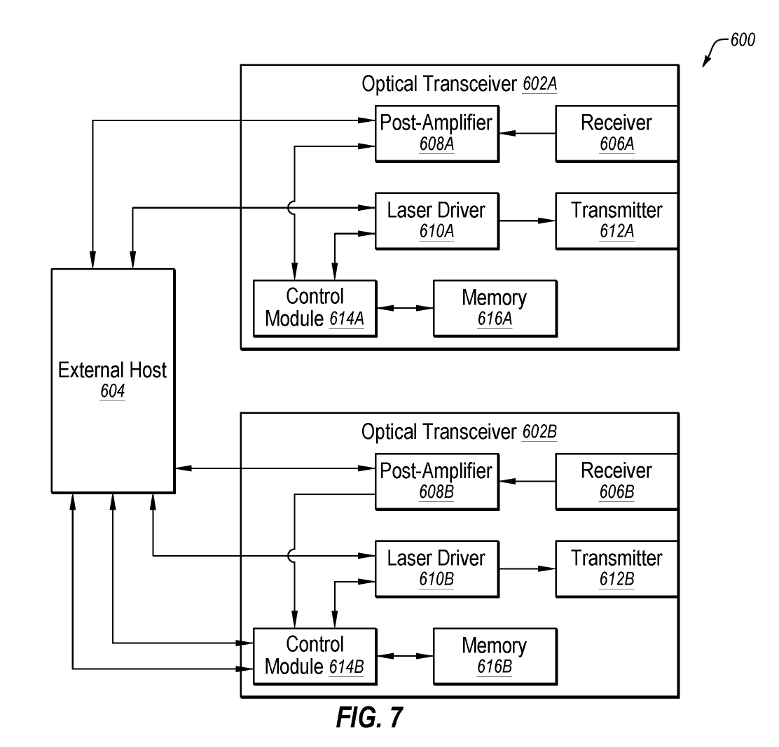

FIG. 6 is a flowchart of an example method 500 for operating an optical communication system. Method 500 may be performed by any suitable system, apparatus, or device. For example, optical system 100 (see FIG. 4), optical system 400 (see FIG. 5), and/or optical system 600 (see FIG. 7), or one or more of the components thereof may perform one or more of the operations associated with method 500. In these and other embodiments, program instructions stored on a computer readable medium may be executed to perform one or more of the operations of method 500.

At block 502, a first transmit signal may be conveyed from a first optical transceiver to a second optical transceiver via an optical fiber and at a first wavelength, and method 500 may proceed to block 504. For example, with reference to FIG. 4, transmitter 108 of optical transceiver 104 may transmit an optical signal at the wavelength to receiver 118 of optical transceiver 106 via optical fiber 124.

At block 504, a second transmit signal may be conveyed from a second optical transceiver to the first optical transceiver via the optical fiber and at a second, different wavelength. For example, with reference again to FIG. 4, transmitter 116 of optical transceiver 106 may transmit an optical signal at the second, different wavelength to receiver 110 of optical transceiver 104 via optical fiber 124. It is noted that the optical signals (i.e., the first transmit signal and the second transmit signal) may simultaneously propagate via optical fiber 124.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

Semiconductor lasers, such as distributed feedback (DFB) lasers, may have, for example, approximately 0.1 nm/Kelvin temperature dependence, whereas CWDM channel widths are, for example, approximately 13 nm wide. Thus, it may be possible to select lasers for two halves (e.g., an upper half and a lower half) of a wavelength range for each CWDM channel (e.g., for an operating temperature range (e.g., approximately 50 Kelvin)).

FIG. 7 illustrates an example system 600 including optical transceivers 602A and 602B and an external host 604. Each optical transceiver 602A and 602B includes a receiver 606, a post-amplifier 608, a laser driver 610, a transmitter 612, a control module 614, and memory 616. While optical transceiver 602 and transmitter 612 are described in some detail below, they are described by way of illustration only, and not by way of limitation. In one example, optical transceiver 602A may include optical transceiver 104 (see FIG. 4) and optical transceiver 602B may include optical transceiver 106 (see FIG. 4). Thus, in this example, transmitter 612A may be configured to transmit a signal to transceiver 602B at a first wavelength (e.g., within a first band of an optical channel), and transmitter 612B may be configured to transmit a signal to transceiver 602A at a second, different wavelength (e.g., within a second band of the optical channel).

As illustrated, for each transceiver 602, receiver 606 is coupled to post-amplifier 608, which is further coupled to control module 614 and external host 604. In addition, transmitter 612 is coupled to laser driver 610, which is further coupled to control module 614 and external host 604. Control module 614 is also coupled to memory 616 and external host 604. By way of example, data may be provided from control module 614 to host 604 via a serial data line. Alternately or additionally, any suitable interface may be implemented for communication between host 604 and control module 614.

According to some embodiments, control module 614 may be configured to access memory 616, which in one embodiment is an Electrically Erasable and Programmable Read Only Memory (“EEPROM”). Memory 616 may also be any other non-volatile memory source. Memory 616 and control module 614 may be packaged together in the same package or in different packages without restriction.

During a contemplated operation of system 600, an optical transceiver (e.g., optical transceiver 602A) may receive one or more optical signals via a receiver (e.g., receiver 606A), which may be configured to transform the one or more optical signals into one or more electrical signals. Further, the receiver (e.g., receiver 606A) may provide the resulting one or more electrical signals to a post-amplifier (e.g., post amplifier 608A), which may amplify the one or more signals and provide one or more amplified signals to an external host (e.g., external host 604). The external host (e.g., external host 604) may be any computing system capable of communicating with one or more optical transceivers (e.g., optical transceivers 602A and 602B).

Further, a transceiver (e.g., optical transceiver 602A) may receive one or more electrical signals from the external host (e.g., external host 604) (e.g., via a laser driver, such as laser driver 610A) for transmission as optical signals. More specifically, the laser driver (e.g., laser driver 610) may receive one or more electrical signals from the external host (e.g., external host 604), and drive a transmitter (e.g., transmitter 612A) to emit one or more optical signals. The transmitter (e.g., transmitter 612) may include a suitable light emitter, such as a VCSEL, DFB laser, or the like, that is driven by an electrical signal provided by the external host, thereby causing the light emitter to emit optical signals representative of the information carried in the one or more electrical signals. Accordingly, in various embodiments, an optical transceiver (e.g., optical transceiver 602A and/or optical transceiver 602B) may function as an electro-optic transducer.

According to various embodiments, a behavior of one or more components of the system may vary dynamically due to a number of factors. For example, the behavior of receiver 606, post-amplifier 608, laser driver 610, and/or transmitter 612 may vary dynamically due to a number of factors. For example, temperature changes, power fluctuations, and feedback conditions may each affect the performance of these components. Accordingly, in some embodiments, control module 614 (e.g., control module 614A) may be configured to receive information from a post-amplifier (e.g., post-amplifier 608A) and/or from a laser driver (e.g., laser driver 610A) and may evaluate environmental conditions, such as temperature, and/or operating conditions, such as emitted optical power and/or wavelength. This may allow for the control module (e.g., control module 614A) to optimize the dynamically varying performance of the transceiver (e.g., transceiver 602A). More specifically, the control module may optimize the operation of the transceiver by adjusting settings on the post-amplifier and/or the laser driver.

Optical transceivers (e.g., optical transceivers 602A and/or 602B) may be implemented in a network that uses wavelength division multiplexing (WDM) to couple optical signals from multiple transmitters into a single optical fiber. In this case, maintaining the optical signal emitted by a transceiver (e.g., optical transceivers 602A or 602B) at constant power and wavelength may be critical to the proper operation of the network. Accordingly, in at least one embodiment, a control module (e.g., control module 614A) may be configured to use a lookup table and/or calibration file to determine desired values for optical power and wavelength of the emitted signal. If the measured optical power and/or wavelength are not at the desired values, the control module may be configured to adjust settings on a laser driver (e.g., laser driver 610A and/or a transmitter (e.g., transmitter 612A) to correct either one or both.

Modifications, additions, or omissions may be made to system 600 without departing from the scope of the present disclosure. For example, optical transceiver 602A and/or optical transceiver 602B may include more or fewer elements than those illustrated and described in the present disclosure.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. An optical system, comprising:
a first transceiver module including at least one transmitter and at least one receiver, wherein each transmitter of the at least one transmitter is configured to transmit a first signal via an optical fiber and at a wavelength; and
a second transceiver module configured to communicate with the first transceiver module via the optical fiber and including at least one transmitter and at least one receiver, wherein each transmitter of the at least one transmitter of the second transceiver module is configured to transmit a second signal via the optical fiber and at another, different wavelength.

2. The optical system of claim 1, further comprising a first transceiver layer including the first transceiver module and a second transceiver layer including the second transceiver module.

3. The optical system of claim 2, further comprising a third transceiver layer including a third transceiver module configured to communicate with the second transceiver module via another optical fiber and including at least one transmitter and at least one receiver, wherein each transmitter of the at least one transmitter of the third transceiver module is configured to transmit a third signal via the another optical fiber and at the wavelength.

4. The optical system of claim 1, further comprising a third transceiver module configured to communicate with the second transceiver module via another optical fiber and including at least one transmitter and at least one receiver, wherein each transmitter of the at least one transmitter of the third transceiver module is configured to transmit a third signal via the another optical fiber and at the wavelength.

5. The optical system of claim 1, wherein the first transceiver module is configured to transmit the first signal in a first portion of each wavelength-division multiplexing (WDM) channel and the second transceiver module is configured to transmit the second signal in a second, different portion of each WDM channel.

6. The optical system of claim 1, wherein the first transceiver module is configured to transmit the first signal in a first band of a wavelength-division multiplexing (WDM) channel and the second transceiver module is configured to transmit the second signal in a second, different band of the WDM channel.

7. The optical system of claim 1, further comprising at least one fiber connector on a fiber link including the optical fiber.

8. The optical system of claim 1, wherein the first signal and the second signal are configured to counter propagate via the optical fiber.

9. An optical system, comprising:
a first transceiver layer including at least one optical transceiver configured to transmit a first optical signal via an optical fiber and at a first wavelength; and
a second transceiver layer including at least one optical transceiver configured to receive the first optical signal via the optical fiber and transmit a second optical signal via the optical fiber and at a second, different wavelength.

10. The optical system of claim 9, further comprising a third transceiver layer including at least one optical transceiver configured to transmit an optical signal at the first wavelength, the at least one optical transceiver of the third transceiver layer configured to communicate with the at least one optical transceiver of the second transceiver layer.

11. The optical system of claim 9, wherein the at least one optical transceiver of the first transceiver layer is configured to transmit the first optical signal in a first portion of each wavelength-division multiplexing (WDM) channel and the at least one optical transceiver of the second transceiver layer is configured to transmit the second optical signal in a second, different portion of each WDM channel.

12. The optical system of claim 9, wherein the at least one optical transceiver of the first transceiver layer is configured to transmit the first optical signal in a first band of a wavelength-division multiplexing (WDM) channel and the at least one optical transceiver of the second transceiver layer is configured to transmit the second optical signal in a second, different band of the WDM channel.

13. The optical system of claim 9, further comprising at least one fiber connector along a fiber link including the optical fiber.

14. The optical system of claim 9, further comprising a switch layer coupled between the first transceiver layer and the second transceiver layer and including one or more optical switches.

15. A method, comprising:
transmitting a first optical signal at a first wavelength from a first optical transceiver to a second optical transceiver via an optical fiber; and
transmitting a second optical signal at a second, different wavelength from the second optical transceiver to the first optical transceiver via the optical fiber.

16. The method of claim 15, wherein transmitting a first optical signal at a first wavelength comprises transmitting the first optical signal in a first portion of each wavelength-division multiplexing (WDM) channel.

17. The method of claim 16, wherein transmitting a second optical signal at a second, different wavelength comprises transmitting the second optical signal in a second portion of each WDM channel.

18. The method of claim 15, further comprising:
transmitting a third optical signal at the first wavelength from a third optical transceiver to the second optical transceiver via a second optical fiber; and
transmitting a fourth optical signal at the second, different wavelength from the second optical transceiver to the third optical transceiver via the second optical fiber.

19. The method of claim 15, wherein transmitting a first optical signal at a first wavelength comprises transmitting the first optical signal in a first band of a wavelength-division multiplexing (WDM) channel.

20. The method of claim 19, wherein transmitting a second optical signal at a second, different wavelength comprises transmitting the second optical signal in a second band of the WDM channel.
